(19) United States
(12) Patent Application Publication
(10) Pub. No.: US 2005/0255962 A1
(43) Pub. Date: Nov. 17, 2005

(54) Roller friction type variable speed device

(76) Inventors: Atsushi Maeda, Gunma-ken (JP); Kazuo Chikaraishi, Gunma-ken (JP)

Correspondence Address: MILES & STOCKBRIDGE PC, 1751 PINNACLE DRIVE, SUITE 500, MCLEAN, VA, 22102-3833, US

(21) Appl. No.: 10/520,920

(22) PCT Filed: Jun. 30, 2003
(86) PCT No.: PCT/JP03/08269

§ 371 Date: Jan. 11, 2005

(30) Foreign Application Priority Data
Jul. 12, 2002 (JP) 2002-204577

(51) Int. Cl. F16H 13/08

(52) U.S. Cl. 476/67

(57) ABSTRACT

A friction roller type transmission includes a first roller (1) and a second roller (2) disposed on two shafts spaced in parallel away from each other so that the first roller (1) and the second roller (2), with the respective shafts being centered, do not contact each other, and a third roller (3) and a fourth roller (4) each of which contacts both of the first roller (1) and the second roller (2), and disposed between the first roller (1) and the second roller (2) and on the sides opposite to a line connecting a center of the first roller (1) and a center of the second roller (2), wherein an angle which is made by a tangential line between the first roller (1) and the third roller (3) (or the fourth roller (4)) and a tangential line between the second roller (2) and the third roller (3) (or the fourth roller (4)) is set not to exceed two times a frictional angle obtained from a coefficient of friction between the respective rollers, and a set load is applied to holding members (20a, 20b) for rotatably holding the third roller (3) or the fourth roller (4) so that the holder members (20a, 20b) are retained in set positions.

### TECHNICAL FIELD

The present invention relates to a friction roller type transmission for transmitting torque in a way that changes a speed by use of friction rollers.

### BACKGROUND ARTS

In friction roller type transmissions disclosed in Japanese patent Application Nos. 2001-159198, 2001-159207, 2002-57541 and 2002-39093 filed by the present inventors prior to the present application, a first roller and a second roller are disposed around two shafts spaced in parallel away from each other so that the first roller and the second roller, with the respective shafts being centered, do not contact each other. A third roller and a fourth roller each of which contacts both of the first roller and the second roller are disposed between the first roller and the second roller and on the side opposite to a line connecting a center of the first roller and a center of the second roller. An angle which is made by a tangential line between the first roller and the third roller (or the fourth roller) and a tangential line between the second roller and the third roller (or the fourth roller) is set not to exceed two times a frictional angle obtained from a coefficient of friction between the respective rollers.

With this construction, it is feasible to build up a transmission route such as the first roller→the third roller→the second roller and a transmission route such as the first roller→the fourth roller→the second roller. In a backlashless friction roller type transmission, the roller can be rotated in forward and reversed directions, an increase in operation torque can be minimized by generating a roller pressing force corresponding to transmission torque, and especially an efficiency in a lower transmission torque area can be improved. Further, the roller for transmitting the power is provided in every rotating direction, wherein the rollers contact each other at all times. Therefore, even when rotated in the reversed direction, the torque can be transmitted by causing neither a delay nor butting noises.

Specifically, an explanation will be given in a state where the third roller transmits the power. Tangential forces generated at a contacting portion between an input shaft (the first roller) and the third roller and at a contacting portion between an output shaft (the second roller) and the third roller, act in such a direction that the third roller is pressed against the first and second rollers. Tangential forces generated at a contacting portion between the first roller and the fourth roller and a contacting portion between the second roller and the fourth roller, conversely act in such a direction that the fourth roller gets separated from the first and second rollers. The angle which is made by the tangential line between the first roller and the third roller (or the fourth roller) and the tangential line between the second roller and the third roller (or the fourth roller) is so set not to exceed two times the frictional angle obtained from a coefficients of friction between the respective rollers, and hence the third roller is, with no slide on the contacting portions with the first roller and second roller, pressed by the tangential forces into between the first roller and the second roller as in the case of a wedge, with the result that a contacting force corresponding to the tangential forces is generated.

The fourth roller, when getting away from the first and second rollers, loses the tangential forces and therefore rolls without being separated in a state of balancing with a pressing load of a spring element.

If the respective components (the rollers, housing and bearings for rotatably supporting the rollers) are perfect rigid bodies, none of elastic deformations are caused. Therefore, even when there increases the pressing load based on the tangential force of the third roller, positional relationships between the first roller and the second roller and between the third roller and the fourth roller remain unchanged. Hence, when the first roller is rotated in the reversed direction, the operation of the third roller is immediately replaced with the operation of the fourth roller, thereby starting the power transmission.

In the earlier applications, however, the holders for rotatably holding the respective third and fourth rollers regulate stroke acting in an interlocking direction by use of their stopper faces provided on the holders. When the torque is inputted, because of taking the structure of extruding the third or fourth roller which becomes a non-transmission side, if the large torque is abruptly inputted, the extrusion of the third or fourth roller which becomes the non-transmission side does not catch up with the timing, and there arises a problem that the holders (especially shaft portions) are damaged.

### DISCLOSURE OF THE INVENTION

It is an object of the present invention, which was devised under such circumstances, to provide a friction roller type transmission capable of preventing damages to holders by retaining the holders in set positions.

To accomplish the above object, a friction roller type transmission according to the present invention comprises a first roller and a second roller disposed around two shafts spaced in parallel away from each other so that the first roller and the second roller, with the respective shafts being centered, do not contact each other, and a third roller and a fourth roller each of which contacts both of the first roller and the second roller, and disposed between the first roller and the second roller and on the side opposite to a line connecting a center of the first roller and a center of the second roller, wherein an angle which is made by a tangential line between the first roller and the third roller (or the fourth roller) and a tangential line between the second roller and the third roller (or the fourth roller) is set not to exceed two times a frictional angle obtained from a coefficient of friction between the respective rollers, and a set load is applied to holding members for rotatably holding the third or fourth roller so that the holder members are retained in set positions.

Thus, according to the present invention, the set load is applied to the holding members so that the holding members for rotatably holding the third or fourth roller are retained in the set positions. With this construction, even when the large torque is abruptly inputted, the extrusion of the third or fourth roller that is the non-transmission side sufficiently catches up with the timing, and it never happens that the holding members (the holders, particularly the shaft portions) are damaged.

Further, according to the present invention, the two holders for respectively rotatably holding the third and fourth rollers are so combined as to be rotatable about one axis, and the spring member attached to the holders is changed into the coil spring from the wire ring disclosed in the earlier application.

Moreover, there is taken a structure for applying a stable and fixed initial contacting force by the coil spring used as the spring member in place of the wire ring. Taken further is a structure, wherein when the third and fourth rollers are more distant from each other than the arbitrarily determined set positions are the set load acts in an approaching direction and when the third and fourth rollers are getting closer to each other than the set positions are in an expanding direction. This structure has a damper effect against the impact while keeping the set positions.

Taken further is the structure in which the two holders are so disposed as to be rotatable about one axis and to face each other, the flange portions are formed with the windows or the grooves which are superposed on each other just when an axis-to-axis distance between the third roller and the fourth roller comes to one between the respective set positions. The coil spring is set in the windows or the grooves to apply the set load. There is also adopted the structure, wherein the holders are rockable from the set positions till the coil spring gets tightly fitted, the spring member applies the force acting to retain the holders in the set positions at that time, and, even when the large torque is abruptly inputted, the holders can be prevented from being damaged owing to the damper effect. The structure is also adopted, wherein the stable and fixed initial contacting force is applied by the coil spring used as the spring member in place of the wire ring.

### BRIEF DESCRIPTION OF THE DRAWINGS

FIG. 1A is a side view of a friction roller type transmission (speed reducer), showing a basic structure of the present invention; FIG. 1B is a schematic perspective view of the friction roller type transmission (the speed reducer) shown in FIG. 1A;

FIG. 2A is a side view of the friction roller type transmission (the speed reducer), showing the basic structure of the present invention (FIG. 2A also shows a transmission route configured by a first roller→a fourth roller→a second roller); FIG. 2B is a similar side view (showing a transmission route configured by the first roller→a third roller→the second roller);

FIGS. 3A through 3C are views each showing the friction roller type transmission (the speed reducer) in an embodiment of the present invention; FIG. 3A is a side view with some portions cut away; FIG. 3B is a sectional view taken along the line b-b in FIG. 3A; FIG. 3C is a sectional view taken along the line c-c in FIG. 3A;

FIG. 4A is an exploded side view showing the third and fourth rollers and a holder; FIG. 4B is a side view showing an assembled state thereof;

FIG. 5A is an exploded side view showing the third and fourth rollers and the holder; FIG. 5B is a perspective view showing an assembled state thereof;

FIG. 6 is a view of operations of the first, second, third and fourth rollers and the holder, showing an initial assembly state;

FIG. 7 is a view of operations of the first, second, third and fourth rollers and the holder, showing a state of returning to a set position;

FIG. 8 is a view of operations of the first, second, third and fourth rollers and the holder, showing a state of being in the set position;

FIG. 9 is a view of operations of the first, second, third and fourth rollers and the holder, showing a maximum rocking position;

FIG. 10 is a view of operations of the first, second, third and fourth rollers and the holder, showing a minimum rocking position;

FIG. 11 is a view of operations of the first, second, third and fourth rollers and the holder in the earlier application, showing a state wherein an axis-to-axis distance between the third roller and the fourth roller is fixed;

FIG. 12 is a front view showing one example of the holder, and showing a positional relationship between the set position and a center of a rocking movement;

FIG. 13A shows a side view and a perspective view in one example of the holder; FIG. 13B shows a side view and a perspective view in a modified example of the holder; and

FIG. 14A shows a side view and a perspective view in another modified example of the holder; FIG. 14B shows a side view and a perspective view in still another modified example of the holder.

### EMBODIMENTS OF THE INVENTION

A friction roller type transmission (speed reducer) according to an embodiment of the present invention will hereinafter be described with reference to the drawings.

(Basic Structure)

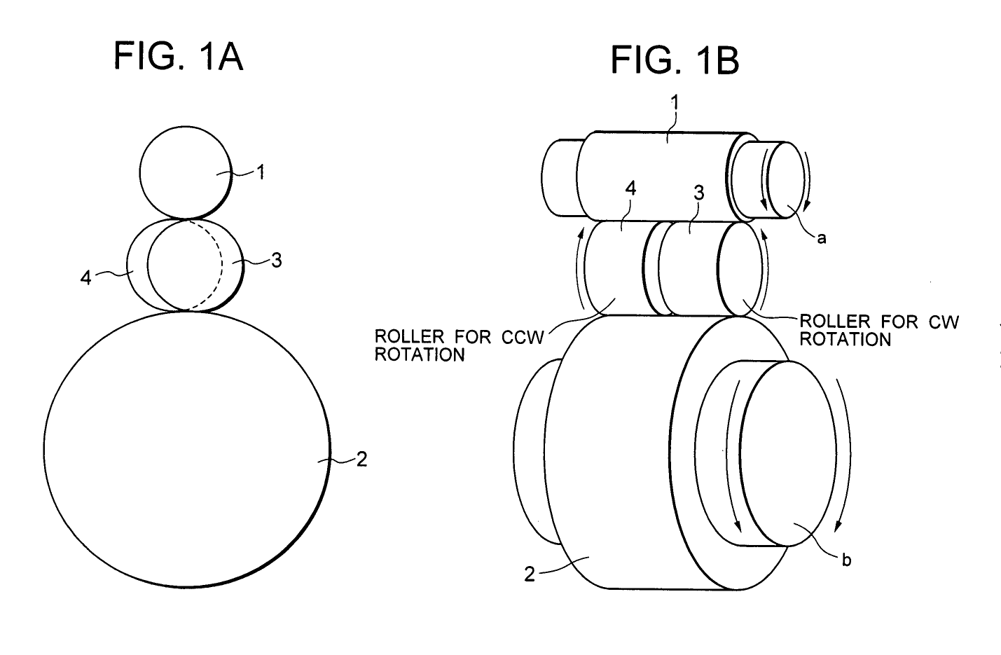

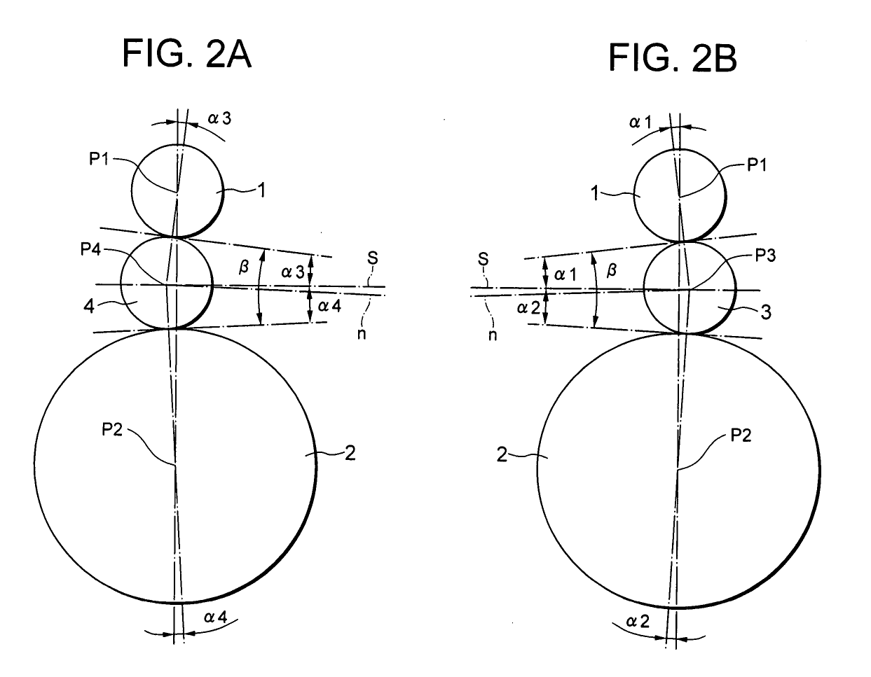

FIG. 1A is a side view of the friction roller type transmission (speed reducer), showing a basic structure of the present invention. FIG. 1B is a schematic perspective view of the friction roller type transmission shown in FIG. 1A. FIG. 2A is a side view of the friction roller type transmission, showing the basic structure of the present invention (FIG. 2A also shows a transmission route configured by a first roller→a fourth roller→a second roller). FIG. 2B is a similar side view (showing a transmission route configured by the first roller→a third roller→the second roller).

According to this basic structure, in the friction roller type transmission (speed reducer), as shown in FIGS. 1A, 1B, 2A and 2B, a first roller 1 having a small diameter and a second roller 2 having a large diameter are fitted respectively onto two shafts a and b spaced in parallel away from each other so that these rollers 1 and 2, the shafts a and b being centered, do not contact each other.

A third roller and a fourth roller, which have preferably the same diameter, are disposed between the first roller 1 and the second roller 2 and on the side opposite to a line that connects a center of the first roller and a center of the second roller so that the third and fourth rollers are in parallel with each other and contact both of these rollers 1 and 2.

The diameter of each of the third and fourth rollers is larger than a shortest distance between a peripheral surface of the first roller and a peripheral surface of the second roller.

An angle which is made by a tangential line between the first roller 1 and the third roller 3 (or the fourth roller 4) and a tangential line between the second roller 2 and the third roller 3 (or the fourth roller 4), is set not to exceed two times a friction angle obtained from a coefficient of friction between the respective rollers, and frictional portions thereof are disposed outside of the rollers.

In other words, let P1 through P4 be centers of the individual rollers, and a sum of an angle made by a line P1P2 and a line P1P3 (α1: ∠P2P1P3) and an angle made by the line P1P2 and a line P2P3 (α2: ∠P1P2P3) and a sum of an angle made by the line P1P2 and a line P1P4 (α3: ∠P2P1P4) and an angle made by the line P1P2 and a line P2P4 (α4: ∠P1P2P4), are set not to exceed two times a friction angle (θ=tan⁻¹μ).

Namely, β=α1+α2=2·tan⁻¹μ, and β=α3+α4=2·tan^{-1μ.}

Note that the contact angle can be defined as an angle which is made by tangential lines and a perpendicular line (s: reference line) perpendicular to a line connecting the center of the first roller and the center of the second roller. Magnitudes of contact forces acting at the contact portions are equal to each other, and hence a resultant force thereof acts in a direction of a bisector (n) of an angle which is made by the respective tangential lines. If diameters of the input/output rollers are equal to each other, the direction of the reference line (s) that defines the contact angle is coincident with the direction of this bisector (n). If there is a difference between these diameters, these directions have a slight deviation. Forces acting from the input/output rollers on a wedge roller in directions of two normal lines (direction that connect the centers) at the contact portions are equilibrated because of the angles made by the aforementioned bisector (n) being equal if considered in a way that sets the bisector (n)(a plane including this bisector (n)) as a reference. The force acting on the wedge roller is considered to be the reference, and the contact angle should be defined on the assumption that the reference is the line (plane) on which the forces acting in the directions at the normal lines at the contact portions are equilibrated.

The frictional angle is small, and therefore in the case of adopting this layout (geometry), the third roller 3 and the fourth roller 4 have no alternative but to take such positions as to be overlapped in their axial directions.

When the configuration given above is taken, a pressing force corresponding to transmission torque is acquired. Accordingly, there is no necessity for the pressing forces (to press the third roller 3 and the fourth roller 4 against the first roller 1 and the second roller 2) needed for the frictional transmission). It is, however, preferable that a minute pressing force for ensuring an initial contacting state be applied in a non-rotational state. Further, the configuration is established by taking one roller element for each roller, however, a plurality of roller elements may also be used for each roller.

The following is an explanation of the operation, wherein the first roller is employed as an input roller.

As shown in FIGS. 1B and 2B, when the first roller 1 is rotated clockwise (in a direction CW), the angle which is made by the tangential line between the third roller 3 and the first roller 1 and the tangential line between the third roller 3 and the second roller 2 is set not to exceed two times the frictional angle, so the respective contact angles are not more than the friction angles and the third roller 3 and the first roller 1 have no relative slide caused at the contacting portion therebetween. Therefore, a tangent-directional force acts on the third roller 3 from the first roller 1. This tangent-directional force acts in a direction of causing the third roller 3 to become closer to the first roller 1, and transfers a force of rotation in a counterclockwise direction (a direction CCW) to the third roller 3.

Also at the contacting portion between the third roller 3 and the second roller 2, the angle which is made by the tangential line between the third roller 3 and the first roller 1 and the tangential line between the third roller 3 and the second roller 2 is so set not to exceed two times the frictional angle, and hence each contact angle does not exceed the frictional angle, whereby the third roller 3 and the second roller 2 have no relative slide caused at the contacting portion therebetween. Therefore, the tangent-directional force acts on the second roller 2 from the third roller 3, and the second roller 2 receives the transfer of the force of rotation in the rotating direction CW. As reaction thereof, a tangent-directional force opposite thereto acts on the third roller 3. This tangent-directional force is a force acting in a direction of bringing the third roller 3 in closer contact with the second roller 2.

The tangent-directional force acting on the third roller 3 is a force acting in a direction of pressing the third roller 3 against the first roller 1 and the second roller 2, thereby making it possible to acquire the pressing force corresponding to the tangent-directional force, i.e., torque to be transferred.

At this time, as shown in FIG. 2A, also on the fourth roller 4, no relative slide occurs at the contacting portion thereof. Hence, the fourth roller 4 receives the tangent-directional force from the first roller 1 and the second roller 2, however, this direction is such a direction that the fourth roller 4 gets away from the first roller 1 and the second roller 2. Consequently, the fourth roller 4 simply rolls as it remains contacting the first roller 1 and the second roller 2.

Next, as shown in FIGS. 1B and 2A, when the first roller 1 is rotated reversely in the direction CCW, the action of the roller 4 is replaced with the action of the third roller 3. The fourth roller 4 has, however, already contacted the second roller 2, whereby the direction of the power transmission can be smoothly converted when rotated in the reversed direction.

Further, it is sufficient for transmitting the torque that the third roller 3 and the fourth roller 4 are in the state of contacting the first roller 1 and the second roller 2. For ensuring the contacting state, there may be obtained minute forces for pressing the third roller 3 and the fourth roller 4 against the first roller 1 and the second roller 2.

Thus, according to the first embodiment, it is feasible to built up the transmission route such as the first roller 1→the third roller 3→the second roller 2 and the transmission route such as the first roller 1→the fourth roller 4→the second roller 2. In the backlashless friction roller type transmission (speed reducer), the roller can be rotated in the forward and reversed directions, an increase in the operation torque can be minimized by generating the roller pressing force corresponding to the transmission torque, and especially an efficiency in a lower transmission torque area can be improved. Further, the roller for transmitting the power is provided in every rotating direction, wherein the rollers contact each other at all times. Therefore, even when rotated in the reversed direction, the torque can be transmitted by causing neither a delay nor butting noises.

### Embodiment of the Present Invention

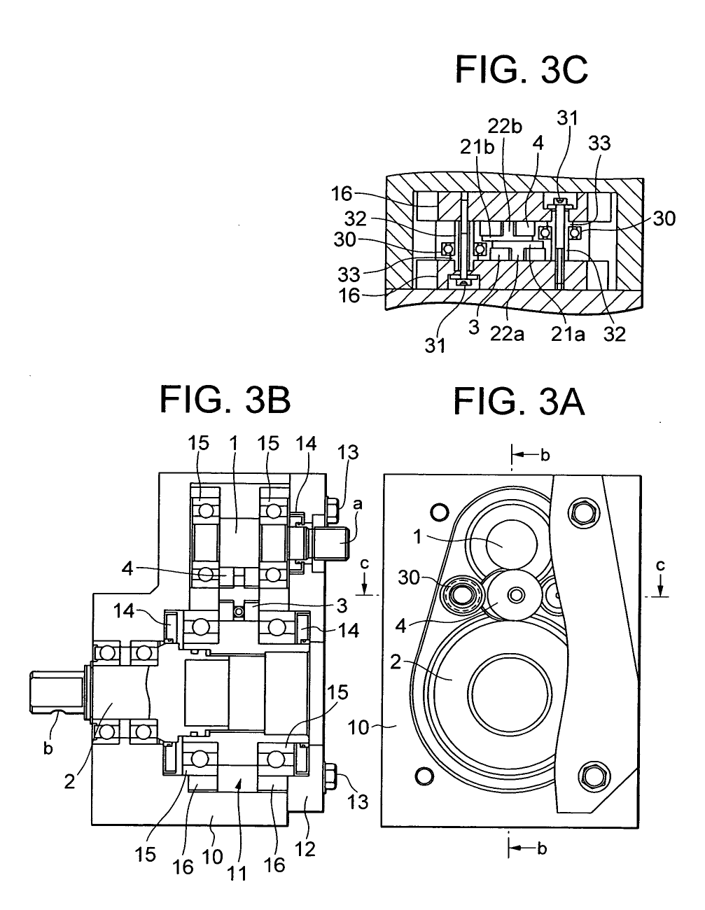

FIGS. 3A through 3C are views each showing the friction roller type transmission (speed reducer) in the embodiment of the present invention. FIG. 3A is a side view with some portions cut away. FIG. 3B is a sectional view taken along the line b-b in FIG. 3A. FIG. 3C is a sectional view taken along the line c-c in FIG. 3A.

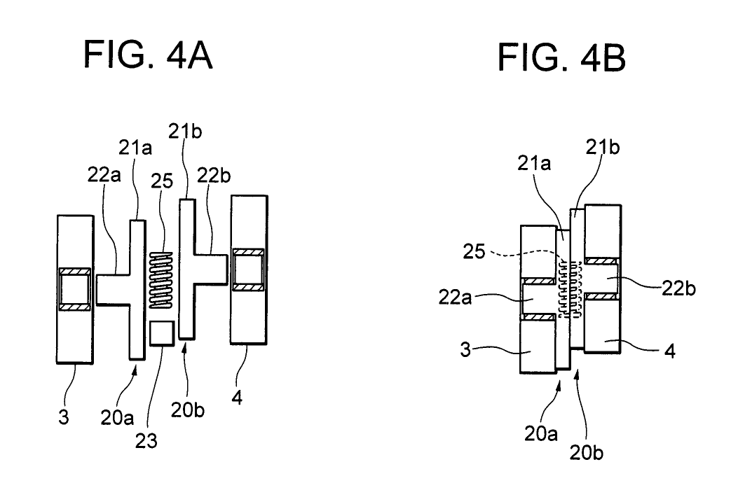

FIG. 4A is an exploded side view showing the third and fourth rollers and a holder. FIG. 4B is a side view showing an assembled state thereof.

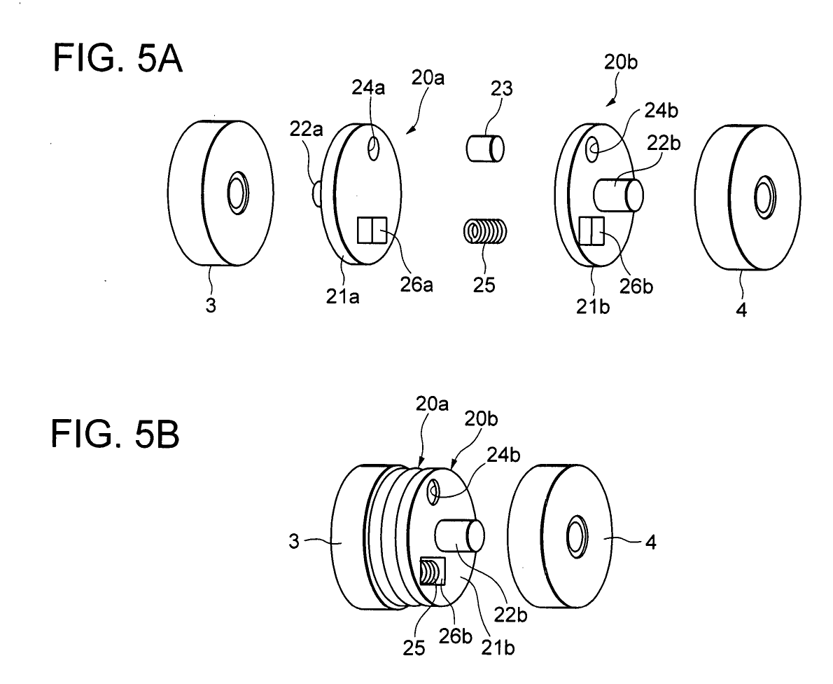

FIG. 5A is an exploded side view showing the third and fourth rollers and the holder. FIG. 5B is a perspective view showing an assembled state thereof.

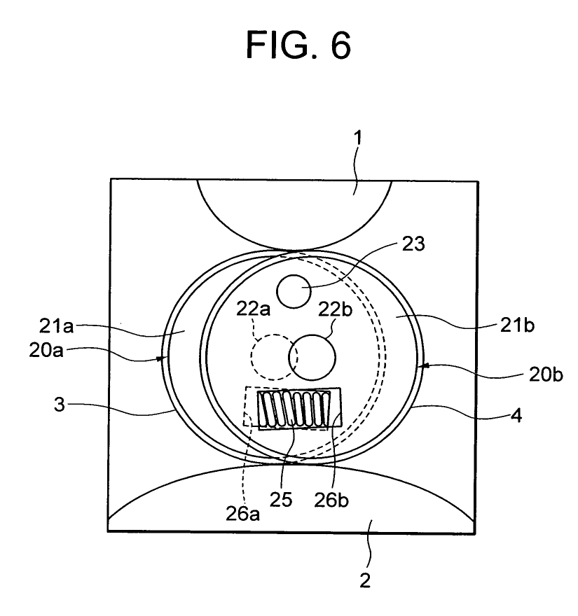

FIG. 6 is a view of operations of the first, second, third and fourth rollers and the holder, showing an initial assembly state.

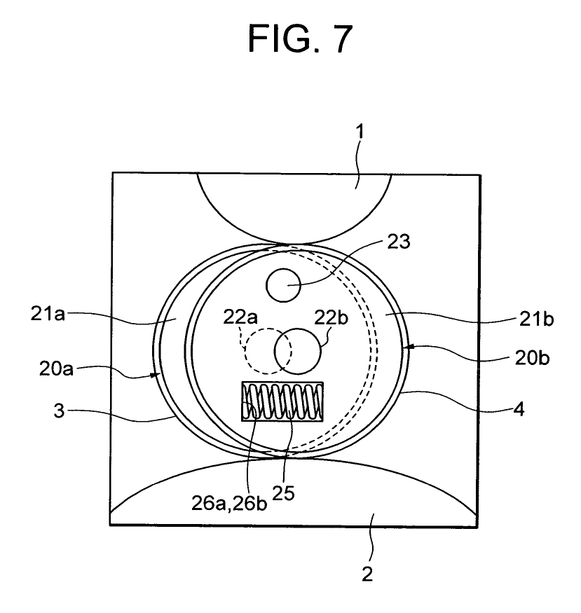

FIG. 7 is a view of operations of the first, second, third and fourth rollers and the holder, showing a state of returning to a set position.

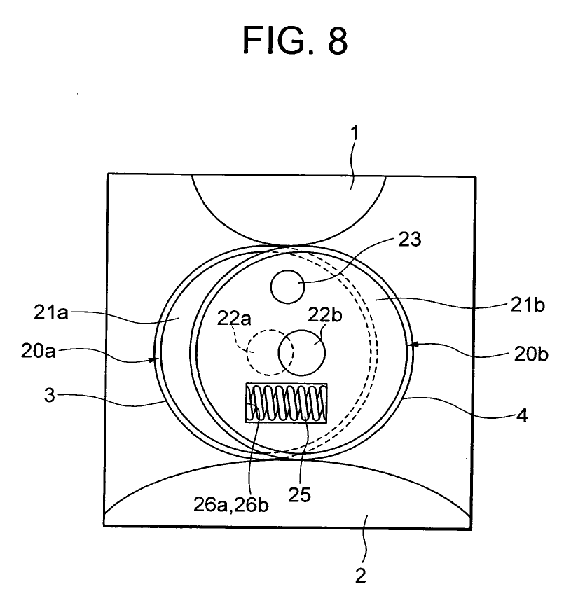

FIG. 8 is a view of operations of the first, second, third and fourth rollers and the holder, showing a state of being in the set position.

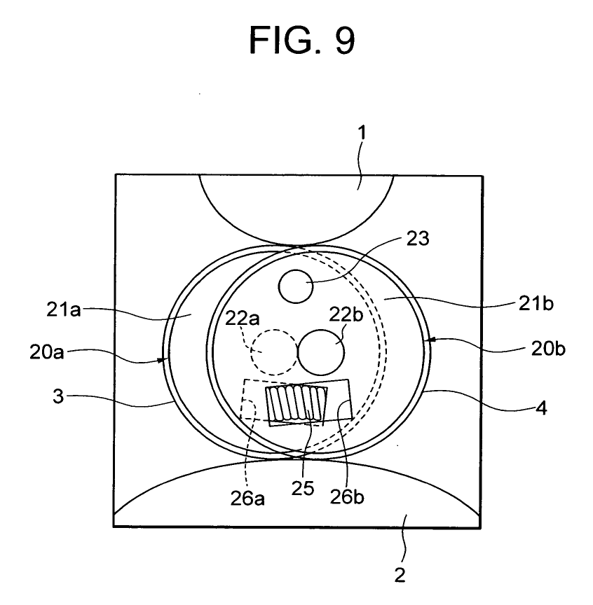

FIG. 9 is a view of operations of the first, second, third and fourth rollers and the holder, showing a maximum rocking position.

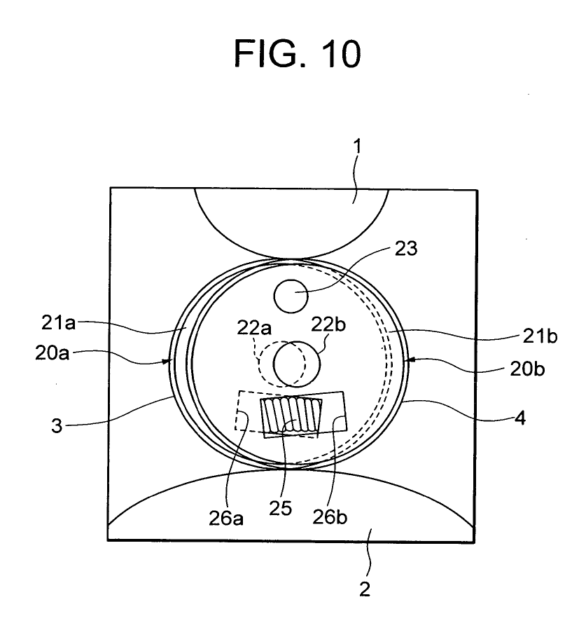

FIG. 10 is a view of operations of the first, second, third and fourth rollers and the holder, showing a minimum rocking position.

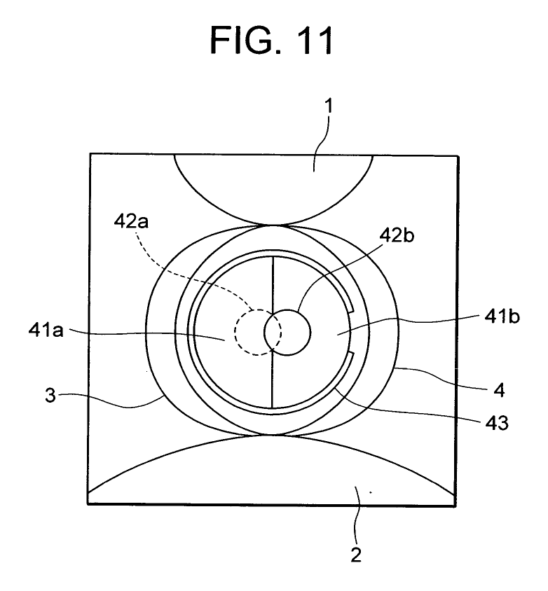

FIG. 11 is a view of operations of the first, second, third and fourth rollers and the holder in the earlier application, showing a state wherein an axis-to-axis distance between the third roller and the fourth roller is fixed.

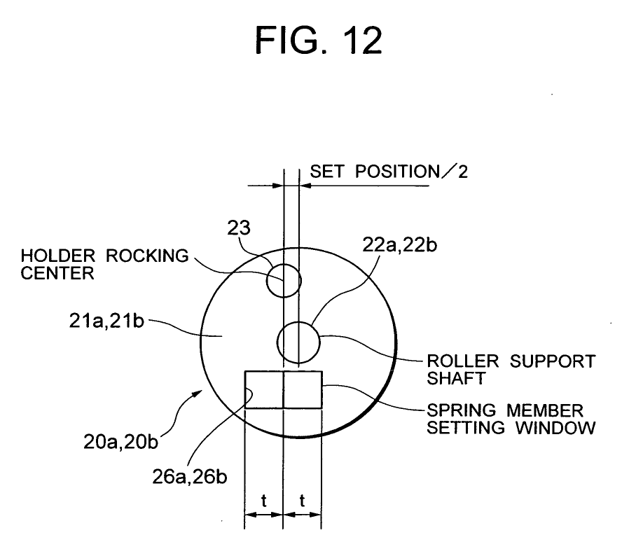

FIG. 12 is a front view showing one example of the holder, and showing a positional relationship between the set position and a central rocking position.

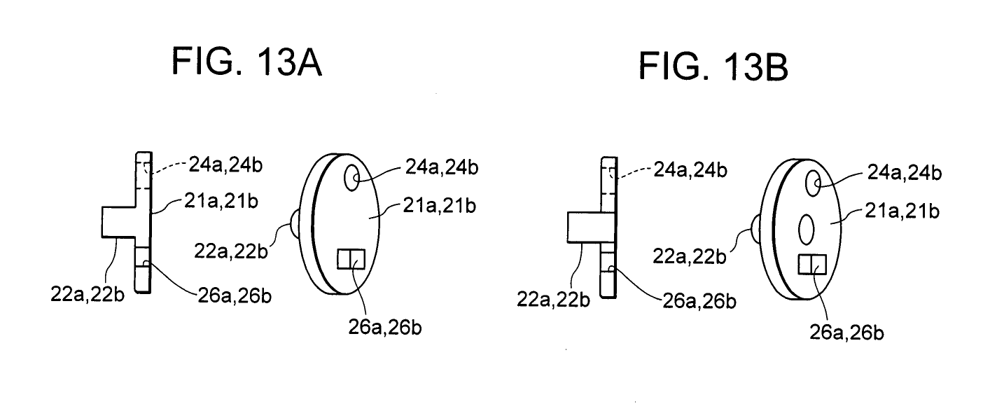

FIG. 13A shows a side view and a perspective view in one example of the holder. FIG. 13B shows a side view and a perspective view in a modified example of the holder.

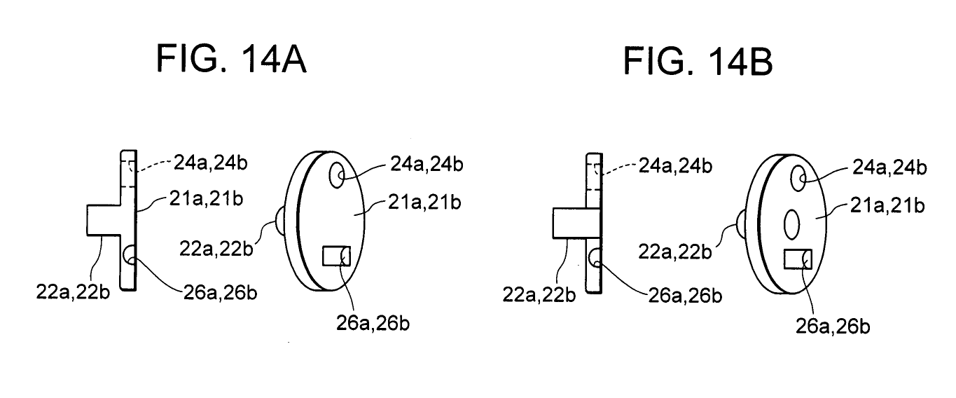

FIG. 14A shows a side view and a perspective view in another modified example of the holder. FIG. 14B shows a side view and a perspective view in still another modified example of the holder.

The present embodiment is what the basic structure described above is embodied. The layout of the first through fourth rollers 1-4, the contact angles and the frictional angles are the same as those in the basic structure.

As shown in FIGS. 3A, 3B and 3C, a housing frame body 10 houses a unit body 11. A cover 12 is secured to the housing frame body 10 by bolts 13. The housing frame body 10 is made of a light weight material such as an aluminum alloy, etc. and can be molded by casting such as die-casting and so on.

Note that seal members 14 are provided on a support portion of an output shaft b of the housing frame body 10 and on a support portion of an input shaft a of the cover 12. Since a slide diameter of the seal can be made smaller than in the case of using a sealed bearing, the increase in operation torque due to friction of the seal can be reduced.

The unit body 11 is provided with two pieces of connecting plates 16 each connects a pair of ball bearings 15 for supporting the first roller 1 and the second roller 2. The connecting plate 16 is made of a material having substantially the same coefficient of linear expansion coefficient as the third roller 3 and the fourth roller 4 have.

The surfaces of the connecting plates 16 are used as slide surfaces for the third roller 3 and the fourth roller 4, however, the two connecting plates 16 each takes a simple plate-like shape, and therefore a finishing work for the slide surface can be easily performed. Further, the connecting plate 16 can be punched out of a plate material by press forming and so on, and the finishing work itself can be also eliminated. Moreover, the same connecting plates can be used with assembling to face each other, so that a cost can be reduced.

As described above, the two connecting plates 16 for connecting the first roller 1 and the second roller 2 in positions of the both ends via the bearings 15, are each made of the material having substantially the same coefficient of linear expansion as the roller has, thus assembling the unit body 11. This unit body 11 is housed in the housing frame body 10 made of the light weight material such as the aluminum alloy, etc., whereby this construction can attain a decrease in weight.

Further, as shown also in FIGS. 4A, 4B, 5A and 5B, a pair of holders 20a, 20b for the third roller 3 and the fourth roller 4 have a pair of disc-shaped flange portions 21a, 21b that face each other.

A pair of shaft portions 22a, 22b for rotatably supporting the third roller 3 and the fourth roller 4 are provided outwardly of the two flange portions 21a, 21b.

A rocking movement pin 23 for supporting the two holders 20a, 20b in a rockable manner in a way that makes these holders 20a, 20b eccentric, is provided between the two flange portions 21a and 21b. The two flange portions 21a, 21b are formed with insertion holes 24a, 24b through which the rocking movement pin 23 is inserted. A coil spring 25 for returning the two holders 20a, 20b to their original positions when the two holders 20a, 20b get rocked, is provided between the two flange portions 21a, 21b. The two flange portions 21a and 21b are formed with accommodating portions 26a, 26b such as windows or grooves, etc. for accommodating the coil spring 25.

Thus, the holders 20a, 20b are capable of rocking about the rocking movement pin 23, corresponding to lateral movements of the third roller 3 and the fourth roller 4. At this time, the coil spring 25, the positions of the accommodating portions 26a, 26b deviating from each other, elastically gets compressed corresponding to this positional deviation and accumulates a larger amount of elastic resilient force as a rocking range becomes larger.

The holders 20a, 20b, when stopping their rocks, return to the set positions by dint of the accumulated elastic resilient force of the coil spring 25.

Provided further is, as shown in FIG. 3C, backup bearings 30 for regulating displacements of the third roller 3 and the fourth roller 4 down to predetermined quantities by contacting the third roller 3 and the fourth roller 4. The backup bearings 30 are, for example, rolling bearings, in each of which an outer race serves as a contacting surface. Thus, the third roller 3 and the fourth roller 4 are prevented from running over by regulating the displacements of the third roller 3 and the fourth roller 4 down to the predetermined quantity, thereby making it possible to prevent the torque transmission route from being destructed due to excessive torque in such a way that the torque which is not less than the predetermined magnitude can not be transmitted.

A pair of bolts 31, 31 are inserted through and thus can be screwed to the connecting plates 16, 16 and the pair of bolts 31, 31 are inserted through a pair of cylindrical spacers 32, 32, respectively. The pair of cylindrical spacers 32, 32 are formed with a pair of flanges 33, 33 respectively. The pair of backup bearings 30, 30 described above are attached respectively to the side faces of the pair of flanges 33, 33.

The bolts 31, 31 are inserted through the cylindrical spacers 32, 32 from the respective end faces thereof on the side of the flanges 33, 33. A gap between the two connecting plates 16, 16 is set to a predetermined dimension as defined by end faces of the flanges 33, 33 of the cylindrical spacers 32, 32 and by end faces, on the opposite sides, of the cylindrical spacers 32, 32.

Subsequently, FIG. 6 shows the initial assembling state by way of the operations of the first, second, third and fourth rollers 1, 2, 3, 4 and holders 20a, 20b.

Forces act on the two holders 20a, 20a in an interlocking direction (approaching direction). When assembled at an initial stage, the third roller 3 and the fourth roller 4 are more distant from each other than the set positions are.

Further, FIG. 7 shows the state of returning to the set positions from the initial assembling state by way of the operations of the first, second, third and fourth rollers 1, 2, 3, 4 and holders 20a, 20b.

When the torque is once inputted, the third roller 3 or the fourth roller 4, which is a transmission side, is brought into interlocking, and the third roller 3 or the fourth roller 4 that is a non-transmission side is bitten in to the set position by the spring force to such an extent that the first roller 1 and the second roller 2 are pressed and the distance therebetween is expanded.

Further, FIG. 8 shows a state of staying in the set positions by way of the operations of the first, second, third and fourth rollers 1, 2, 3, 4 and holders 20a, 20b.

Even when the input torque is set to 0 in the set positions, the third roller 3 or the fourth roller 4 does not slide due to a wedge effect, the set positions remain unchanged.

Moreover, FIG. 9 shows a state of being in the maximum rocking position by way of the operations of the first, second, third and fourth rollers 1, 2, 3, 4 and holders 20a, 20b. In this maximum rocking position, the forces act on the two holders 20a, 20b in the interlocking direction.

Thus, the holders 20a, 20b respectively can rock about the rocking movement pin 23, corresponding to the lateral movements of the third roller 3 and the fourth roller 4. At this time, the coil spring 25, the positions of the accommodating portions 26a, 26b deviating from each other, elastically gets compressed corresponding to this positional deviation and accumulates the larger amount of elastic resilient force as the rocking range becomes larger.

The holders 20a, 20b, when stopping their rocks, return to the set positions by dint of the accumulated elastic resilient force of the coil spring 25.

Further, FIG. 10 shows a state of being in the minimum rocking position by way of the operations of the first, second, third and fourth rollers 1, 2, 3, 4 and holders 20a, 20b. In this minimum rocking position, the forces act on the two holders 20a, 20b in the expanding direction in order to return to the set positions.

Moreover, FIG. 11 shows operations of the first, second, third and fourth rollers 1, 2, 3, 4 and holders 20 according to the earlier application. The holders 20 are constructed of flange portions 41a, 41b and shaft portions 42a, 42b. The flange portions 41a, 41b and the shaft portions 42a, 42b are eccentric with predetermined quantities, and the flange portions each takes substantially a semi-circular shape in section. The holders can abut on each other with the shaft portions 42a, 42b set opposite to each other, and have, when abutting on each other, one continuous annular groove in their outer peripheral surfaces. A wire ring 43 defined as a spring element is fitted in this annular groove and applies an elastic force to the two shaft portions 22 in such a direction as to decrease a distance between the two shaft portions 22 so that these shaft portions 22 get close to each other and integrality is attained. The third roller 3 and the fourth roller 4 are rotatably supported by the shaft portions 22 of the respective holders 20.

Thus, according to the earlier application, the gap between the shaft portions 42a and 42b is fixed, and hence the third roller 3 and the fourth roller 4 have the fixed axis-to-axis distance and are therefore unable to rock mutually separately.

Furthermore, FIG. 12 shows a positional relationship between the set positions and the rocking centers in one example of the holders.

The shaft portions 22a, 22b and the rocking movement pin 23 are offset by halves (½) of the set positions.

The accommodating portions 26a, 26b such as the windows or the grooves, etc. in which the coil spring 25 is set, show line symmetry with respect to the rocking center of the holder (the rocking movement pin 23), and the two holders 20a, 20b are constructed such that the accommodating portions 26a, 26b such as the windows or the grooves, etc. are superposed on each other when in the set positions.

Further, FIG. 13A shows one example of the holders 20a, 20b. According to this example, in the holders 20a, 20b, the flange portions 21a, 21b are integral with the respective shaft portions 22a, 22b and are formed respectively with the window-shaped accommodating portions 26a, 26b in which the coil spring 25 as the spring member is fitted.

Moreover, FIG. 13B shows a modified example of the holders 20a, 20b. According to this modified example, in the holders 20a, 20b, the flange portions 21a, 21b are formed separately from the shaft portions 22a, 22b, and are formed with the window-shaped accommodating portions 26a, 26b in which the coil spring 25 as the spring member is fitted.

Furthermore, FIG. 14A shows another modified example of the holders 20a, 20b. According to this modified example, in the holders 20a, 20b, the flange portions 21a, 21b are integral with the respective shaft portions 22a, 22b, and are respectively formed with the groove-shaped accommodating portions 26a, 26b in which the coil spring 25 as the spring member is fitted.

Moreover, FIG. 14B shows still another modified example of the holders 20a, 20b. According to this modified example, in the holders 20a, 20b, the flange portions 21a, 21b are formed separately from the shaft portions 22a, 22b, and are formed with the groove-shaped accommodating portions 26a, 26b in which the coil spring 25 as the spring member is fitted.

Note that the holders 20a, 20b are respectively constructed of the flange portions 21a, 21b and the shaft portions 22a, 22b in the embodiment discussed above, wherein the flange portions 21a, 21b and the respective shaft portions 22a, 22b are coaxial, and the flange portions 21a, 21b each takes the circular shape in section. The flange portions 21a, 21b are respectively formed with the circular holes 23 about which the respective holders 20a, 20b are rotated, and formed with the windows or grooves 26 in which the coil spring 25 is set. The holders 20a, 20b can abut on each other with the shaft portions 22a, 22b set opposite to each other, wherein the set positions correspond to position in which the windows or groves 26 formed in the two holders 20a, 20b are superposed on each other. The coil spring 25 defined as the spring element is fitted in the windows or grooves 26 formed in the holders 20a, 20b. To the holders 20a, 20b is applied a set load in the approaching direction when the two shaft portions 22a, 22b are more distant from each other than the set positions are and in the expanding direction when the two shaft portions 22a, 22b are less distant from each other than the set positions are.

It should be noted that the present invention is not limited to the embodiment discussed above and can be modified in a variety of forms.

As discussed above, according to the present invention, the set load is applied to the holding members so that the holding members for rotatably holding the third or fourth roller are retained in the set positions. With this construction, even when the large torque is abruptly inputted, extrusion of the third or fourth roller that is the non-transmission side sufficiently catches up with the timing, and it never happens that the holding members (the holders, particularly the shaft portions) are damaged.

Further, according to the present invention, the two holders for rotatably holding the third or fourth roller are so combined as to be rotatable about one axis, and the spring member attached to the holders is changed into the coil spring from the wire ring used in the earlier application.

Moreover, there is taken the structure for applying the stable and fixed initial contacting force by the coil spring used as the spring member in place of the wire ring. Taken further is the structure, wherein the set load is applied in the approaching direction when the third and fourth rollers become more distant from each other than the arbitrarily determined set positions are and in the expanding direction when getting closer to each other than the set positions. This structure has a damper effect against the impact while keeping the set positions.

Taken further is the following structure. The two holders are so disposed as to be rotatable about one axis, and the flange portions are formed with the windows or the grooves superposed on each other just when the axis-to-axis distance between the third roller and the fourth roller comes to the set position in the case of making the holders face each other. The coil spring is set in the windows or the grooves, and the set load is applied. There is also adopted the structure, wherein the holders are rockable from the set positions till the coil spring gets tightly fitted, the spring member applies the force acting to retain the holders in the set positions at that time, and, even when the large torque is abruptly inputted, the holders can be prevented from being damaged owing to the damper effect. The structure is also adopted, wherein the stable and fixed initial abutting force is applied by the coil spring used as the spring member in place of the wire ring.

1. A friction roller type transmission comprising:
a first roller and a second roller disposed around two shafts spaced in parallel away from each other so that said first roller and said second roller, with said respective shafts being centered, do not contact each other; and
a third roller and a fourth roller each of which contacts both of said first roller and said second roller, and disposed between said first roller and said second roller and on the side opposite to a line connecting a center of said first roller and a center of said second roller,
wherein an angle which is made by a tangential line between said first roller and said third roller (or said fourth roller) and a tangential line between said second roller and said third roller (or said fourth roller) is set not to exceed two times a frictional angle obtained from a coefficient of friction between said respective rollers, and
a set load is applied to holding members for rotatably holding said third or fourth roller so that said holder members are retained in set positions.

2. A friction roller type transmission according to claim 1, wherein said holding member is constructed of flange portions formed integrally or separately and of a pin.

3. A friction roller type transmission according to claim 1, wherein said holding member is formed with windows or grooves in which a spring member is fitted.
